(19) United States
(12) Patent Application Publication
(10) Pub. No.: US 2002/0157511 A1
(43) Pub. Date: Oct. 31, 2002

(54) Method and apparatus to prepare trim cap material for bending

(76) Inventor: Randolph M. Linenberger, Denver, CO (US)

Correspondence Address: MERCHANT & GOULD PC, P.O. BOX 2903, MINNEAPOLIS, MN, 55402-0903, US

(21) Appl. No.: 09/844,954

(22) Filed: Apr. 26, 2001

Related U.S. Application Data
(60) Provisional application No. 60/199,933, filed on Apr. 26, 2000.

(51) Int. Cl. B26D 3/00

(52) U.S. Cl. 83/39; 83/628; 83/683; 83/917

(57) ABSTRACT

The invention provides an improved method and apparatus to prepare trim cap material for bending, the apparatus comprising at least one notcher and at least one dimpler employed: (1) to notch the trim cap material to facilitate bending, but ensuring that the notch is not so large or deep so as to result in cracking when the trim cap material is bent resulting in unsightly appearance and performance deficiencies when the trim cap is installed as part of a completed sign and (2) to dimple the trim cap material so that the dimple is visible from both sides of the trim cap material.

This application claims the benefit of provisional patent application serial No. 60/199/933 filed on Apr. 26, 2000.

### I. FIELD OF THE INVENTION

The present invention is directed generally toward a method and apparatus to prepare trim cap material for bending. More specifically, it relates to techniques and equipment for punching notches in a sheet of trim cap material to facilitate the process of fabricating products from the trim cap material, and to techniques and equipment for marking or dimpling the trim cap material in a manner that indicates to a fabricator how to further process the trim cap material.

### II. BACKGROUND OF THE INVENTION

In the sign industry, three-dimensional signs are frequently formed by attaching side panels, or returns, to cut-out shapes (e.g., letters). These cutout shapes form the front and back panels of the fully assembled sign, and the returns give the sign its three-dimensional characteristic. The trim cap is similar in function to a return, and is generally a side panel attached to the front panel of a fully assembled sign. The trim cap generally fits snugly on the outside of the return to assist in keeping the two major components of the sign together—the front panel with attached trim cap and the back panel with an attached return—and to from a seal to prevent moisture and other materials from penetrating into the sign.

In the fabrication of articles from trim cap material (e.g., metal, plastic, or other material), it is necessary to bend the trim cap material in well-defined places to form specific configurations. Normally, the trim cap material is forced manually around the front panel in the shape of the letter. As a predicate to bending the trim cap material, it is at times necessary both to remove any material that impedes bending from the trim cap material before commencing a bending operation, and to mark or dimple the trim cap material to indicate the desired bend location and the desired bend direction. Enough material must be removed so as to allow bending of the trim cap material, but not so much material that when the trim cap material is bent cracking or other problems result that could result in leakage of moisture or an inadequate seal.

In order to facilitate bending of the trim cap material, it is beneficial to both remove portions of the material and to indicate on the material itself how it should be further processed. It is necessary to remove material so that, if the trim cap material is bent back upon itself during further fabrication, it does not buckle. For example, one or more notches may be removed from the material to allow the trim cap material to be bent back upon itself. It is beneficial to indicate on the material itself how it should be further processed so that it is easier for the fabricator who is tasked with bending the trim cap material to quickly grasp the required bend locations and directions. The location of the notches provides some indication to a fabricator that the material is to be bent in the vicinity of the notches. The fabricator must, however, know rather precisely the location and direction of the bends to be made. Not all bends require notching. Marks on the trim cap material indicate the specific location and direction of the bends.

In the absence of automatic bending machinery, manual bending methods are used. These manual bending methods normally require the marking of the material to indicate the exact place of the bend and the direction of the bend. Traditionally, this marking has been done with pencils, hand punches, or other markers, and the necessary measurements have been made with ordinary measurement devices. To do this, skill and care are required in order to make each bend properly. Since the material may have been cut, punched, or notched on automatic machinery before reaching the fabricator for final processing, it is desirable for this same machinery to be able to mark the material (when it is cut, punched, or notched) to indicate the point of a bend and the direction of the bend.

Currently automated machines utilized to process trim cap either bend or only partially process the trim cap material. Devices that currently attempt to bend the finished shape without removing any material to facilitate bending are only partially effective. The finished shape must comply with the restrictions imposed by not actually notching the material, which limits the possible range of bending. Because of this, the material can not be properly formed to all desired shapes. Other automated machines actually cut the notches but do not indicate bend direction. Moreover, these specific units do not indicate bends in the down direction.

### III. BRIEF SUMMARY OF THE INVENTION

It is desirable to be able to prepare trim cap material for bending during a single pass through an apparatus and to simultaneously indicate bending information (e.g., bend location and direction) on the trim cap material without using any printers. Accordingly, it is an object of the disclosed invention to provide an improved method and apparatus to prepare trim cap material for bending. The invention comprises an apparatus for preparing trim cap material for bending, including removing necessary material from said trim cap material and marking said material to indicate a bend location and a bend direction. It includes at least one notcher positioned such that the trim cap material passes through the notcher. The notcher removes enough material from said trim cap material to facilitate bending but not so much material that the trim cap material cracks upon bending or cannot form a seal. At least one dimpler is positioned such that the trim cap material passes under the dimpler, and said at least one dimpler creates a dimple in said trim cap material that is visible from both sides of said trim cap material.

The invention also comprises a method for preparing trim cap material for bending, including removing surplus material from said trim cap material and marking said trim cap material to indicate a bend location and a bend direction. This method comprises: (1) notching the trim cap material to facilitate bending, but ensuring that the notch is not so large or deep so as to result in cracking when the trim cap material is bent resulting in unsightly appearance of the completed sign and possible defects in the seal between the frontpanels and the return; (2) dimpling the trim cap material using at least one dimpler such that the dimple is visible from both sides of said trim cap material.

A more detailed explanation of the invention is provided in the following description and claims, and is illustrated in the accompanying drawings.

### IV. BRIEF DESCRIPTION OF THE DRAWINGS

FIG. 1 is a perspective view of the top, front, and left end of the apparatus that prepares the sheet stock for bending according to the present invention.

FIG. 2 is a perspective view of the top, front, and right end of the apparatus depicted in FIG. 1.

FIG. 3 is a perspective view of the top, front, and right end of the apparatus depicted in FIGS. 1 and 2.

FIG. 4 is a perspective view of the top and left end of a section of trim cap material that has been prepared for bending by the apparatus depicted in FIGS. 1-3.

FIG. 5 is a perspective view of the bottom of the processed section of trim cap material depicted in FIG. 4.

FIG. 6 is a view of the top, bottom and side of a processed section of trim cap material depicted in FIGS. 4 and 5, and contains details of the notches, dimples, and various dimensions.

FIG. 7 is a schematic view of a notcher employed in the apparatus depicted in FIGS. 1-3.

FIG. 8 is a schematic view of a dimpler employed in the apparatus depicted in FIGS. 1-3.

FIG. 9 is a schematic view of the shear employed in the apparatus depicted in FIGS. 1-3.

### V. DETAILED DESCRIPTION

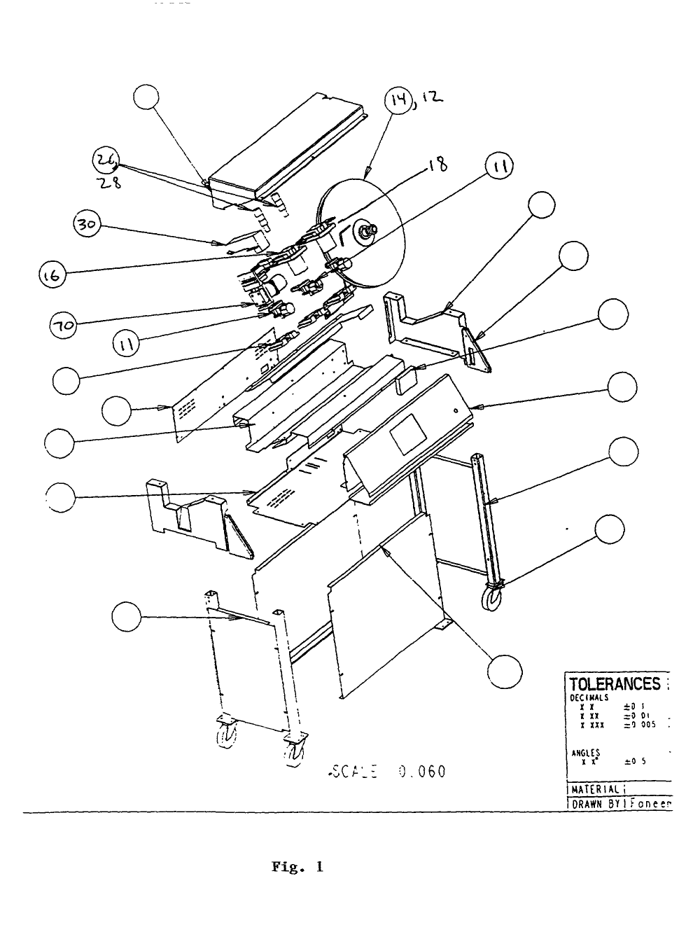

Referring first to FIG. 1, an apparatus 10 to prepare trim cap material 12 for bending is shown adjacent to a material dispenser 14 for handling and feeding coiled trim cap material 12 into the apparatus 10 that prepares such trim cap material 12 for bending. In addition to the items specifically enumerated on FIG. 1, the complete apparatus may also include side, bottom and rear support pieces (such as those depicted in broken away format in FIG. 1) to support the operative mechanical elements described herein. A computer system with a graphic users interface and touch screen provides the user with the means of importing a DXF file representing the face of the shape to be processed. Also included in the interface are tools to set up the job manually operate the machine, feed the material and automatically run all of the various tools and components. This system moves, measures the material and places the required notches, dimples or cuts to fully automate the production of letter trim ready for gluing to the face of the shape described in the DXF file.

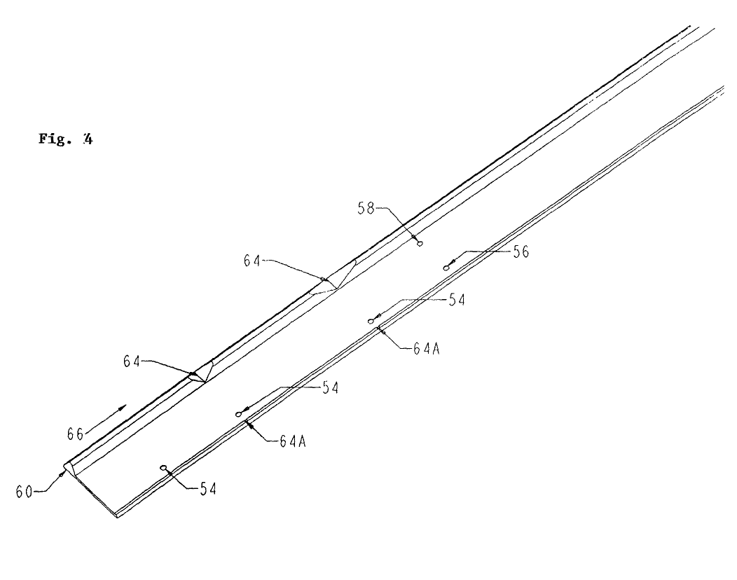

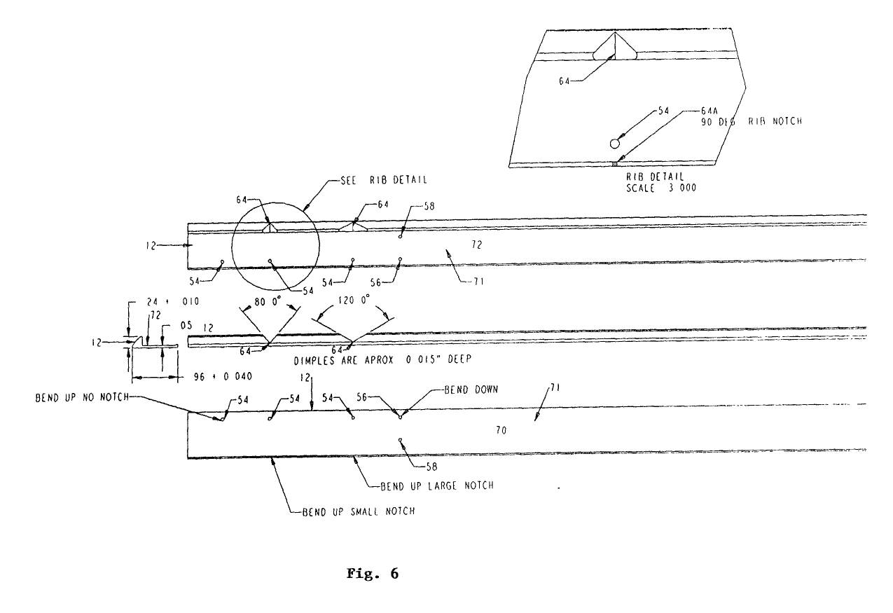

A processed piece of the trim cap material 12 stock is illustrated in FIGS. 4-6. The trim cap material 12 includes a reinforced section 60, or face, that rises above the inside surface 72 of the trim cap material 12. The face or reinforced section 60 will be visible on the outside of the finished sign. Rear reinforced area 60a is used to stiffen the material and to provide a form of a gasket or drip edge to help prevent moisture from entering the enclosure. The outside surface 70 of the trim cap material 12 is substantially flat. The body 71 of the trim cap material 12 is bounded by the outside surface 70 and the inside surface 72, and the face or reinforced section 60 protrudes from the body 71. As is clearly visible in FIGS. 4 and 6, the reinforced section 60 of the trim cap material 12 that has been processed contains one or more cut-outs or notches 64, 64a.

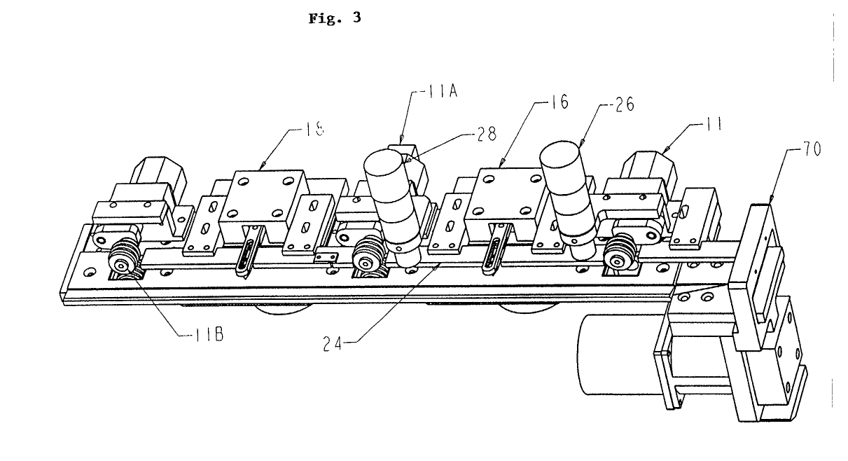

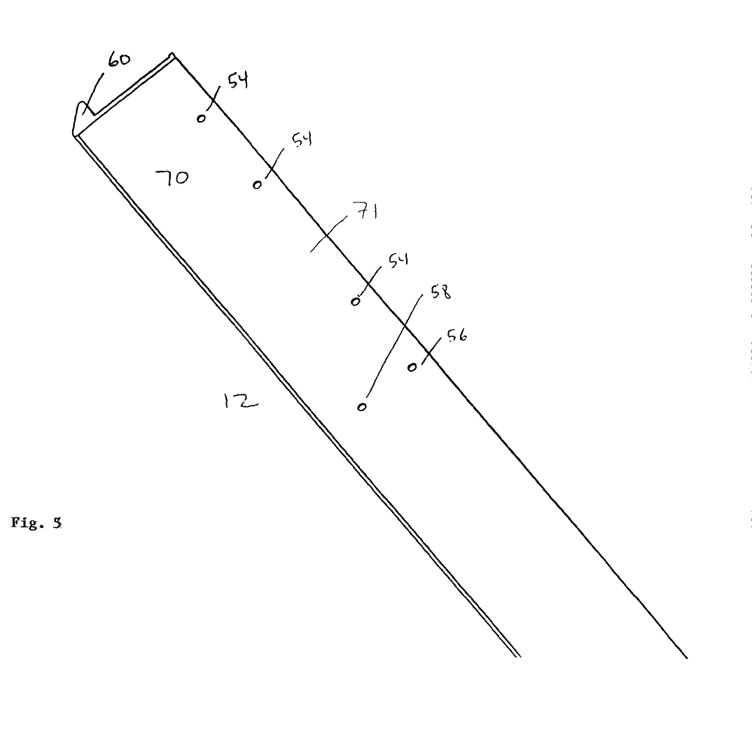

Referring now to FIGS. 4-6, details of the trim cap material 12 that is output from the apparatus 10 after it has been processed will be described. FIG. 4 is a perspective view of the top and left end of a section of trim cap material 12 that has been prepared for bending by the apparatus 10 depicted in FIGS. 1-3. FIG. 5 is a perspective view of the bottom of the processed section of trim cap material 12 depicted in FIG. 4. FIG. 6 is a view of the top, bottom and side of a processed section of trim cap material depicted in FIGS. 4 and 5, and contains details of the notches, dimples, and various dimensions.

The notches 64, 64a are placed by the notchers 16, 18 in the thicker part of the trim cap material 12, including front reinforced area 60 and rear reinforced area 60a. Accordingly, the notch should be to a depth sufficient to facilitate bending without the formation of cracks during bending or subsequently during the life of the sign. If the notch 64 and 64a is too deep, the trim cap material 12 can crack when bent, which results in obvious aesthetic disadvantages (e.g., cracks for light escape) and a potential for leakage of moisture into the sign. If the notch 64, 64a is too shallow, the bending of the trim cap material 12 will not be sufficiently facilitated. The appropriate depth of the notch 64, 64a will vary based on the composition of the trim cap material 12 and other factors, and one of ordinary skill in the art will appreciate that other depths of the notch 64, 64a will be satisfactory and within the scope of this invention.

The rear reinforced section 60a runs parallel to 60. This rear reinforced area 60a raises 45 thousandths of an inch above surface 72. In the preferred embodiment, the notch 64 and 64a created by notchers 16,18 will be between 10 thousandths and 20 thousandths of an inch above the inside surface and does not penetrate the body 71 of the trim cap material 12. The non reinforced section at the back of the material 60a is notched with a secondary adjustable cutter attached to the notcher tool 22 to provide a 90 degree notch 64a adjacent to the main notch. Providing a notch in this portion of the material causes the resultant bed to be formed more easily, helps assure that the bend is square and reduces the radius of the finished bend.

In the preferred embodiment, the trim cap material 12 has a thickness of approximately 46 thousandths of an inch (the distance between the inside surface 72 and the outside surface 70). The reinforced section 60 rises approximately 200 thousandths of an inch above the inside surface 72. In the preferred embodiment, the notch 64, 64a created by the notchers 16, 18 will be between 10 thousandths and 20 thousandths of an inch above the inside surface and does not penetrate the body 71 of the trim cap material 12.

As clearly shown in FIGS. 4-6, dimples 54, 56, 58 are contained in the trim cap material 12 and are associated with the notches 64, 64a, As previously discussed, the number or arrangement of the dimples 54, 56, 58 lets a fabricator know precisely where to make a bend and in which direction to bend the trim cap material 12. In the applicants' preferred embodiment, a single dimple 54 indicates an upward bend along a line that is perpendicular to the longitudinal axis 66 and contains the dimple 54. Also per the preferred embodiment, a dimple pair like dimples 56, 58 indicates a back bend to a fabricator shaping the processed trim cap material 12 into a final configuration. The fabricator would make a back bend along a line that is both perpendicular to the longitudinal axis 66 of the trim cap material 12 and contains both dimples 56, 58 of the dimple pair. Clearly, a single dimple 54 could indicate a back bend, and a dimple pair 56, 58 could indicate an up bend, depending upon the preference of the fabricator. By comparing FIGS. 4 and 5, it is clear that the dimples 54, 56, 58 made in the trim cap material by the dimplers 26, 28 during processing of the trim cap material 12 through the apparatus 10 are visible on both the inside surface 72 and the outside surface 70 of the processed trim cap material 12.

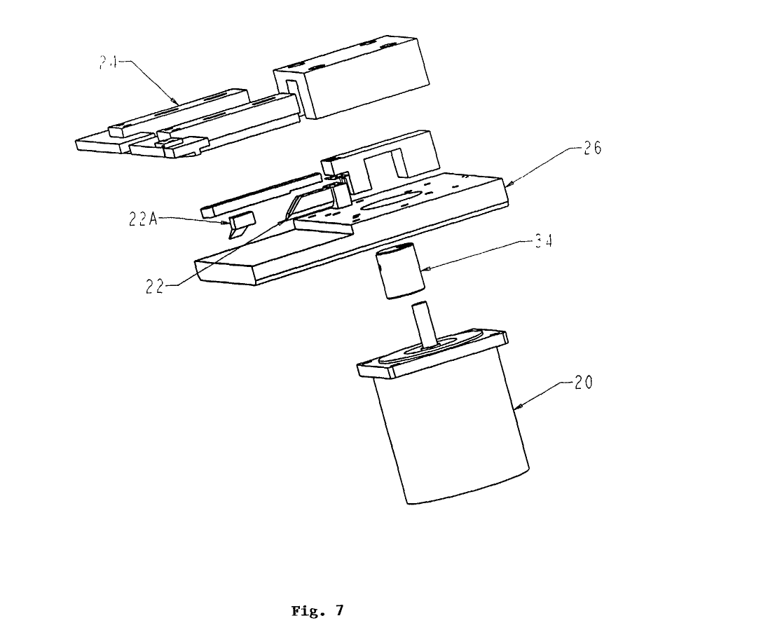

In the preferred embodiment, the apparatus 10 will decoil the trim cap material 12 continuously from a standard shipping reel, or material dispenser 14 (cut strips of a known length can be utilized, processing of these cut strips is allowed for in the software ). As shown in FIG. 1, the trim cap material 12 is pulled from the material dispenser 14 into the apparatus 10 for processing. Pinch rollers 11B mounted on the apparatus 10 pull the trim cap material 12 through the apparatus 10 at a predetermined processing speed. Referring to FIGS. 1-3, it is possible to see a first notcher 16 and a second notcher 18, which comprise part of the apparatus 10. These notchers 16, 18 are mounted so that, in the preferred embodiment, the trim cap material 12 passes in front of tool 22 and upper material guide 24 (see FIG. 7) comprising part of each notcher 16, 18. Details of the notchers 16, 18 are described further below in connection with the discussion of FIG. 7.

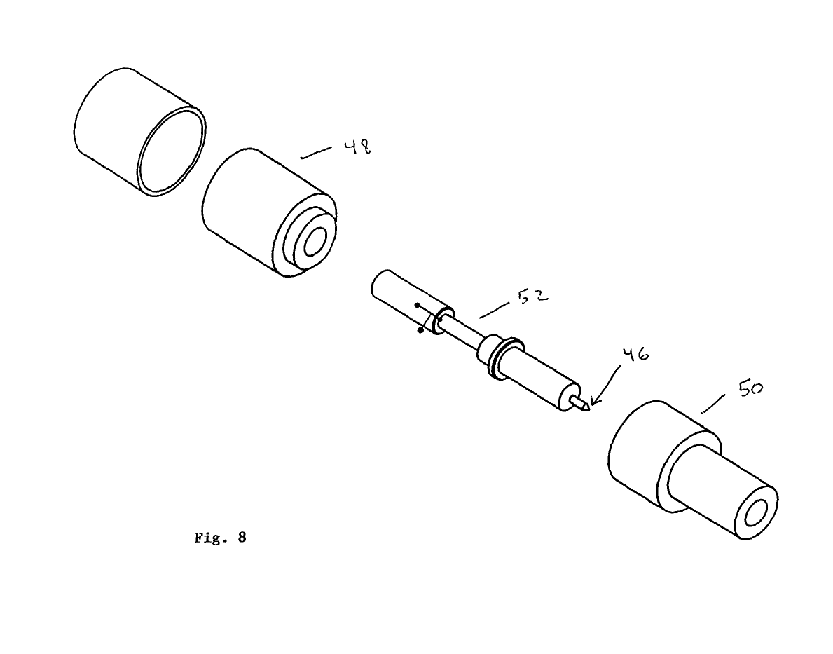

After the trim cap material 12 is notched, it continues to pass right to left through the apparatus 10 as shown in, for example, FIGS. 1-3, and passes undo a first dimpler 26 and a second dimpler 28 located on the apparatus 10. These dimplers 26, 28 are described in detail below in the discussion of FIG. 8.

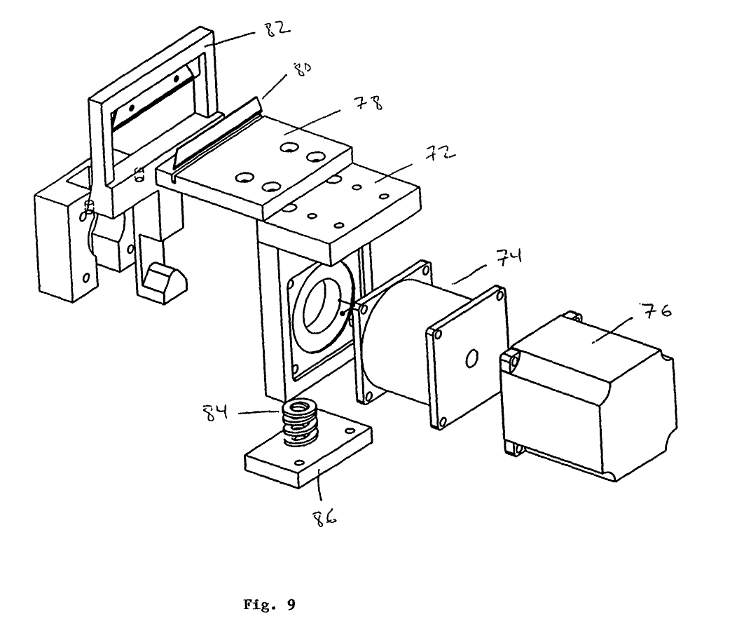

Processing of the continuous strip of trim cap material 12 continues in this manner until the desired length of trim cap material 12 has been notched and dimpled. At that point, a shear 70 (depicted in detail in FIG. 9), which is mounted under a housing 30 for safety reasons, cuts the trim cap material 12 substantially perpendicular to the longitudinal axis 66 of the trim cap material 12. This processed piece of trim cap material 12 is then further processed manually or in additional machines until the final product configuration desired is obtained.

The trim cap material 12 is pulled through the apparatus 10 through the use of pinch rollers 11B mounted on the apparatus 10. The pinch rollers 11B are driven by material motors 11 (shown in FIG. 1) at a predetermined processing speed. In the preferred embodiment, the material motors 11 are stepper motors. The predetermined processing speed of the trim cap material 12 through the apparatus 12 is dependent upon the operation speeds of the notchers 16, 18, the dimplers 26, 28, and the shear 70, in addition to limitations of the material motors 11. In the current preferred embodiment, the fastest predetermined processing speed of the trim cap material 12 is approximately four inches per second (4 inch/sec). Encoder 11A measure the trim cap material 12 as it moves through the apparatus 10. The encoder 11A is designed to reduce or prevent slippage. Both the notchers 16, 18 and the shear 70 have a switch (not shown) to sense the position of the tool.

In the preferred embodiment, adjustable guides 24 allow the apparatus 10 to accept trim cap material 12 in standard widths of, for example, 0.75″, 1″, and 2″. Also in the preferred embodiment, the trim cap material 12 is fed into the apparatus with the flat side facing downward. Known manufactures of material processed by the apparatus include Gemini, Inc. or Wagner Zip-Change, Inc. of Melrose Park, Ill. (operating under the trade name “Jewelite”) and Silva Trim Corp. of America (South Plainfield, N.J.).

Referring now to FIG. 7, the notchers 16, 18 are described next. In the preferred embodiment, the notchers 16, 18 are substantially interchangeable. The first notcher 16 may comprise a tool 22 which is either an 80 degree or 120 degree tool in the preferred embodiment, with an adjustable 90 degree secondary notcher attached 22A, as well as a stepper motor 20 and a cam 34, which together drive each notcher 16, 18. The trim cap material 12 travels between the upper material guide 24 and the tool block 26.

The notchers 16, 18 used in the apparatus 10 of the present invention differ from the prior art in several ways. Traditional punches are typically either hydraulically, pneumatically, inertially actuated, or cut with a rotating blade. In the case of manually operated punchers or notchers, compound levers are used to activate the punchers or notchers. When punching material, it is necessary to apply considerable pressure quickly, and these prior art methods provide for the application of stored energy to the actual punch mechanism quickly, thereby minimizing the necessity for high peak consumption from a primary power source. Such prior art mechanisms suffer from the problem that the sudden application of force to the punch produces loud and sudden noises, and delivers a substantial jarring impact to the entire apparatus 10. Thus, when traditional punches are used, it is often necessary to substantially reinforce the structure supporting the punchers. Rotating blades (e.g., saws) are also noisy and the removal process creates pieces of small debris (e.g., dust particles) that are hard to control in a manner safe to both operators and equipment.

In contrast, the notchers 16, 18 described herein use electrical energy as their prime power source, but provide for the application of the required force at the proper time via a mechanism that has not been previously used for this purpose. Referring to FIG. 7, the tool 22 is driven through trim cap material 12 by the cam 34, which is rotated by means of the motor 20. The motor 20 may be a DC motor, an AC motor, an hydraulic motor, a pneumatic motor, or any other source of rotational power. In the preferred embodiment, a stepper motor 20 is used. As this stepper motor 20 rotates the cam 34 through a full cycle, the velocity of the tool 22 is made rather high until the leading edge of the tool 22 reaches the surface of the trim cap material 12 being punched, and then the velocity is reduced as the tool 22 makes its way through the trim cap material 12. Finally, the configuration of the cam 34 is such that the tool 22 is removed quickly after the punching action has reached the desired point. In the preferred embodiment, the cam 34 is a simple eccentric cam. These velocity changes facilitate rapid processing of trim cap material 12 by the apparatus 10. In the preferred embodiment, the notchers 16, 18 create approximately one notch per second. Two notches per second can possibly be created, but can result in a degradation of performance.

In the preferred embodiment, the use of a stepper motor 20 permits accurate control of the position and velocity of the tool 22 as it is cycled through the trim cap material 12. Further, since a stepper motor 20 is reversible, in the event that an attempt is made to punch trim cap material 12 that exceeds the capacity of the tool 22, the tool 22 can be reversed to free the trim cap material 12 from the tool 22 if it becomes jammed.

A principal advantage to the cam action just described is that the speed of the tool 22 may be made high when little power is required (i.e., when the tool 22 is not being driven through the trim cap material 12) and slow when a high degree of power is required (e.g., when the tool 22 is being driven though the trim cap material 12). Driving the tool 22 through the trim cap material 12 at a slow speed with high power is in contrast to prior punching techniques in which a tool 22 strikes the trim cap material 12 at a high velocity, thereby creating considerable noise and jarring the entire apparatus 10. Since the shape of the cam 34 determines the speed at which the tool 22 is driven (i.e., the velocity profile of the tool 22), different shapes of the cam 34 can easily be provided to change the velocity profile when different materials are to be processed. In this manner, the punching action can be configured depending upon the type and thickness of material to be processed.

In the preferred embodiment, there are two different notchers 16, 18. An 80 degree notcher is used to notch the trim cap material 12 when the desired bend for the sign is between 40 degrees and 120 degrees and is in the up direction. An 120 degree notcher is used to notch the trim cap material 12 when the desired bend for the sign is between 120 degrees and 180 degrees. See FIG. 6 for a comparison of different sizes of notches 64, 64a that can be created by 80 degree and 120 degree notchers of the preferred embodiment. Moreover, the use of multiple notches (notch spreading) can be used in the preferred embodiment to vary the angle of the notch 64, 64a and the desired bend angle.

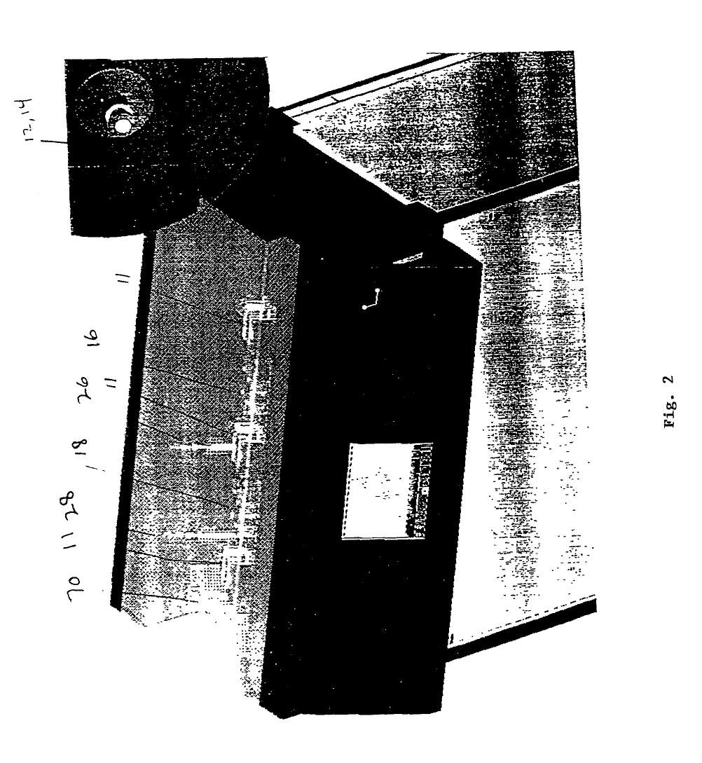

Referring now to FIG. 8, details of the dimplers 26, 28 (see also FIGS. 1-3) are described next. The apparatus 10 of the present invention uses a first dimpler 26 and a second dimpler 28 (shown in context in, for example, FIG. 2) to mark trim cap material 12 to indicate the point of a desired bend that will be subsequently made as well as the direction of that bend. This marking of the trim cap material 12 facilitates fabrication of a product from the notched and dimpled section of trim cap material 12 after it leaves the apparatus 10 depicted in FIGS. 1-3.

FIG. 8 is a schematic representation of the dimplers 26, 28 that are mounted on the apparatus 10. As shown in FIGS. 1-3, in a preferred embodiment of the present invention, two marking punches or dimplers 26, 28 are provided on the apparatus 10. As may be seen in FIG. 8, in this preferred embodiment, each dimpler 26, 28 includes a dimple point 46 of hardened steel attached to a punch 52, which is actuated by an electrical solenoid 48. A return spring (not shown), which is located between the punch 52 and the housing 50, biases the dimple point 46 away from the trim cap material 12 that is being processed in the apparatus 10. Further, when the electrical solenoid 48 is activated, the punch 52 drives the dimple point 46 downward and to the right in FIG. 8 until it impacts the trim cap material 12 passing beneath it in the apparatus 10. Alternatively, the dimplers 26, 28 could be actuated by hydraulic pistons, pneumatic pistons, or other devices. The electrical solenoid 48 employed in the preferred embodiment, however, requires low power and makes it unnecessary for the apparatus 10 to be further complicated by hydraulic or pneumatic systems.

The solenoid 48 must be able to drive the dimple point 46 with sufficient force to adequately mark or dimple the trim cap material 12. The required force varies depending upon the type of material being processed and its thickness. Further, it is preferred that a dimple (e.g., 54 in FIGS. 4 and 5) generated by each dimpler 26, 28 be visible on both sides of the trim cap material 12 so that someone processing the notched and dimpled material produced by the apparatus 10 of FIGS. 1-3 does not have to continually refer to one particular side of the trim cap material 12 for bending information. At the appropriate location for a bend, one or both of the dimplers 26, 28 are activated resulting in one or more dimples (compare 54 in FIGS. 4 and 6 with 56 and 58 in FIGS. 4 and 6) being created on the trim cap material 12. In the preferred embodiment, a single dimple (e.g., 54 in FIGS. 4 and 6) indicates a first bend direction and a pair of dimples (e.g., 56, 58 in FIGS. 4 and 6) indicates a second, opposite bend direction. Thus, someone actually forming a product configuration from the notched and dimpled material knows from merely reviewing the number or pattern of dimples at a particular location, not only that a bend is to occur at that location, but also whether that bend is to be up or down. Similar results could be achieved by using a single dimpler and, for example, firing it two times in rapid succession to create a pair of adjacent dimple marks (not shown) using only one dimpler. An advantage of using dimplers 26, 28 instead of printers, in addition to the fact that the dimples (e.g., 54, 56, 58) will be visible from each side of the processed sheet stock (compare FIGS. 4 and 5), is that no ink or other consumables are required. Further, it is not necessary to maintain the expensive printing equipment required by machines that merely print bending information on the trim cap material 12 as it is processed. Additionally, the dimples 54, 56, 58 cannot smear or smudge like ink and, therefore, provide a less vulnerable indication of subsequent bending information. Since, in the preferred embodiment, the dimples 54, 56,58 are made along what ultimately becomes a bending line, these dimples 54, 56, 58 are substantially hidden in the creases of the bent trim cap material 12 of the final product.

FIG. 9 is a schematic representation of the shear 70 of the apparatus 10. As shown in FIGS. 1-3, in a preferred embodiment of the invention, a shear 70 is provided with the apparatus 10 to cut the trim cap material 12 substantially perpendicular to the longitudinal axis 66 of the trim cap material 12 when the desired length of trim cap material 12 is reached. As shown in FIG. 9, the tool block 72 is connected to the gear head 74 and a stepper motor 76. The cutting table 78 is mounted on top of the tool block 72. The trim cap material 12, when moving through the shear 70, is on top of the cutting table 78. A knife blade 80, connected to a guillotine 82, is positioned above the trim cap material 12. When the cam (not shown) drives the knife blade 80 down to the surface of the cutting table 78, the trim cap material 12 is cut by the knife blade 80. The cutting table 78 contains a slot, aligned with the knife blade 80, that allows the knife blade 78 to cut the trim cap material 12. The cam (not shown) is driven down by the stepper motor 76. The knife blade 80 is returned to its rest position by tension from a spring 84 mounted on a spring base 86 that provides tension to the combination of the tool block 72 and cam (not shown). In the preferred embodiment, the shear 70 can cut the trim cap material 12 in less than two seconds.

The cuts, notches, and dimples described herein need to be accurately performed by the invention. The preferred embodiment uses a software program to control the cuts, dimpling, and notching so as to provide the shape of the letter described in an imported computer file (e.g., a file in the .DXF or HPGL formats). The present embodiment includes a CPU-driven user interface with a LCD display and a touch-screen for ease of use. In the present embodiment, the software used is essentially the same as the software used for an apparatus to notch and mark return shop material. The preferred embodiment allows for the use of a network configuration to allow data files to be accessed from a central server or floppy disk or other removable media to input data files into the apparatus 10.

Although preferred embodiments of this invention have been described above, those skilled in the art could make numerous alterations to the disclosed embodiments without departing from the spirit or scope of this invention. For example, although two notchers 16, 18 and two dimplers 26, 28 are shown and described as comprising the preferred embodiment, any number of notchers or dimplers could be used. An important feature of the present invention is the simplicity of the notchers 16,18, and the mark (e.g., 54, 56, 58) generated by the dimplers 26, 28 that is visible on both sides of the trim cap material 12. The notchers 16, 18 of the present invention are of a simple modular design and require low power stepper motors 20 and a simple cam 34 to achieve the necessary punching and notching of the trim cap material 12 as it passes through the apparatus 10. Such stepper motors 20 are easily controlled by a computer (contained, for example, in the housing of the apparatus 10 as depicted in FIGS. 1-3) if full automation of the sheet stock processing is desired, and no mechanical interconnections other than the direct connections between the stepper motor 20 and the notchers 16, 18 are necessary. All directional references (e.g., upper, lower, upward, downward, left, right, leftward, rightward, top, bottom, above, below, vertical, and horizontal) above are used only for identification purposes to aid the reader's understanding of the present invention, and do not create limitations, particularly as to the position, orientation, or use of the invention. It is intended that all matter contained in the above description or shown in the accompanying drawings shall be interpreted as illustrative only and not limiting.

1. An apparatus for preparing trim cap material having a reinforced section for bending, including removing necessary material from said trim cap material at the point of said bending and marking said trim cap material to indicate a bend location and a bend direction, said apparatus comprising
at least one notcher that removes material at a bend location sufficient to facilitate bending but without the formation of cracks during bending or subsequently during the life of the trim cap material, and
at least one dimpler that creates a dimple in said trim cap material that is visible from both sides of said trim cap material.

2. The apparatus of claim 1, further comprising at least one shear that cuts said trim cap material at an appropriate position.

3. A method for preparing trim cap material having a reinforced section for bending, including removing necessary material to facilitate bending from said trim cap material and dimpling said trim cap material to indicate a bend location and a bend direction, said method comprising:
notching said trim cap material using at least one notcher that removes material at a bend location sufficient to facilitate bending but without the formation of cracks during bending or subsequently during the life of the trim cap material, and
dimpling said trim cap material using at least one dimpler that creates a dimple in said trim cap material that is visible from both sides of said trim cap material.
